(19) United States
(12) Patent Application Publication
(10) Pub. No.: US 2008/0271103 A1
(43) Pub. Date: Oct. 30, 2008

(54) Controlling Access to Broadcast Services in a Terminal Device

(75) Inventor: Anne-Marie Praden, Ventabren (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 12/158,649

(22) PCT Filed: Dec. 19, 2006
(86) PCT No.: PCT/EP2006/069904

§ 371 Date: Jun. 20, 2008

(30) Foreign Application Priority Data
Dec. 22, 2005 (FR) 0554054

(51) Int. Cl. H04N 7/173

(52) U.S. Cl. 725/116

(57) ABSTRACT

Services are distributed via a distribution network to terminal devices. One of the services is an electronic service guide stored in the terminal devices and providing descriptive data on the distributed services. To control access to the services distributed to a terminal device, the device includes a module for filtering descriptive data on the distributed services in accordance with at least one filtering criterion, and a graphics module for displaying the filtered descriptive data that meets the filtering criterion so as to enable services associated with the displayed filtered descriptive data to be selected.

The present invention relates to controlling access to services that are broadcast by a broadcasting network.

More particularly, it relates to controlling access to broadcast services when the access control is executed by an Electronic Service Guide (ESG) module that is incorporated in a user terminal device.

A broadcasting network to which the invention is applicable can be a one-way network and transmit service signals to all of the user devices connected to the network, certain services being accessible only as a function of an access right. The applications that are the most well known are broadcasting of television and/or radio-broadcasting signals, e.g. via a data broadcasting network of any of the following types: DVB (Digital Video Broadcasting), DAB (Digital Audio Broadcasting), DMB (Digital Multimedia Broadcasting), DTT or DTTV (Digital Terrestrial Television), ISDB-T (Integrated Services Digital Broadcasting—Terrestrial), MBMS (Multimedia Broadcast Multicast Service) and BCMCS (Broadcast Multicast Service) over mobile telephone networks such as third-generation or fourth-generation mobile telephone networks etc., or the Internet. In another example, a Wireless Local Area Network (WLAN) can be used as the broadcasting network. The invention also applies to the system defined by the OMA-BCAST (Open Mobile Alliance—Broadcast) specification.

A broadcasting channel of a broadcasting network transmits a number of services that varies as a function of the passband available for transmitting data. In order to enable a user to discover all of the services broadcast via the broadcasting network, at least one description service for describing the broadcast services and referred to as an “Electronic Service Guide” (ESG) is proposed. The description service is broadcast by the broadcasting network, or transmitted by a point-to-point telecommunications network such as a cellular radiocommunications network, to user mobile terminals at their request.

The electronic service guide contains various information about the services broadcast by the broadcasting network. Those services are, for example, television programs including, in particular, films, documentaries, and/or magazines. The electronic service guide constitutes the point of access to the services that are broadcast more particularly for the user of a mobile terminal. Depending on the information in the guide, users select a service that they wish to obtain, e.g. for viewing purposes.

Giving access to the services broadcast by the broadcasting network for all audiences goes against restricting viewing of services that are for viewing by one category of users only.

For example, a child can then view a service that is intended exclusively for adults.

In another example, certain services are broadcast by an operator who is a competitor of the initial operator whom the user chose and who supplied the terminal device to said user. The initial operator can then not restrict the available services to only those services that it provides and/or that are provided by a partner.

In order to mitigate those drawbacks, a “Conditional Access System” (CAS) or “Key Management System” (KMS) supplied by a service broadcasting operator makes service viewing on a terminal device conditional upon possessing a right of access to the services that the operator is broadcasting. Those services are encrypted before being broadcast over the broadcasting network. In order to view the service, the user must first purchase access rights, represented in the form of a decryption key, from the operator who is offering the service.

Unfortunately, no protection prevents viewing of certain services that are broadcast unencrypted over the broadcasting network but that are unsuitable, for example, for children.

There is thus a need to have a protection system that is capable of enabling a possessor of a terminal device to restrict viewing of services broadcast unencrypted over a broadcasting network.

An object of the invention is to provide access control for controlling access to services that are broadcast by a broadcasting network, which access control is implemented directly in a user terminal device, in order to restrict access to those services on the basis of specific criteria.

In order to achieve this object, a method of controlling access to broadcast services that are broadcast via a broadcasting network, one of the services being an electronic service guide stored in the terminal device and containing description data that describes the other broadcast services, is characterized in that it comprises: filtering the items of description data of the electronic service guide that relate to the broadcast services as a function of at least one filter criterion; and presenting the filtered items of description data that satisfy the filter criterion so that the services associated with the presented filtered items of description data are selectable.

An advantage of the invention is that it is possible, directly in the terminal device, to control access to all of the services broadcast over the broadcasting network, both encrypted services and services that are broadcast unencrypted. The access control is performed directly in the terminal by interpreting the electronic service guide service that contains the description data describing said other services broadcast over the network, and by filtering said description data as a function of one or more filter criteria.

In a first variant of the invention, the filtered items of description data that satisfy the filter criterion are stored, and, on activation of the electronic service guide, the stored filtered items of description data are presented.

In a second variant of the invention, all of the items of description data of the electronic service guide are stored, and, on activation of the electronic service guide, the stored items of description data are filtered as a function of the filter criterion to be satisfied, and are then presented.

According to a characteristic of the invention, the filtering of the description data relating to a broadcast service comprises, for each broadcast service: comparing an item of description data describing the broadcast service with a filter criterion parameter.

According to another characteristic of the invention, provision is made for decrypting the description data describing the broadcast services before filtering the items of description data that relate to the broadcast services.

A filtering criterion may depend on a digitized code corresponding to parental control and/or on an identifier of an operator managing the broadcasting network or of a partner of the operator.

Previously, the method of controlling access to broadcast services preferably further comprises: selecting from among the broadcast service signals, that service signal that relates to the electronic service guide and that includes the description data describing the other broadcast services, the items of description data describing a service including an identifier identifying the service and also being included in the service itself in order to present the description data describing the service and in order to select the service.

The invention also provides a terminal device having access control for controlling access to broadcast services that are broadcast via a broadcasting network, one of the services being an electronic service guide stored in the terminal device and containing description data that describes the other broadcast services. The terminal device is characterized in that it comprises: means for filtering the items of description data of the electronic service guide that relate to the broadcast services as a function of at least one filter criterion; and means for acting, on activation of the electronic service guide, to present the filtered items of description data that satisfy the filter criterion so that only those services that are associated with the presented filtered items of description data are selectable.

In a first embodiment of the invention, the terminal device comprises a mobile terminal including the filter means, means for storing the description data, and the presentation means.

According to other characteristics of the first embodiment, the mobile terminal includes means for decrypting the description data describing the broadcast services, and a memory card is associated with the terminal and stores said at least one filter criterion.

In a second embodiment of the invention, the terminal device comprises a terminal including the presentation means, and a smart card associated with the terminal including the filter means and means for storing the description data.

According to a characteristic of the second embodiment, the smart card includes means for decrypting the description data describing the broadcast services.

Finally, the invention provides a program suitable for being implemented in a terminal device for the purpose of controlling access to broadcast services that are broadcast via a broadcasting network, said program comprising instructions which, when the program is executed in said terminal device, implement the steps of the method of the invention.

Other characteristics and advantages of the present invention appear more clearly on reading the following description of preferred embodiments and implementations of the invention, given by way of non-limiting example and with reference to the corresponding accompanying drawings, in which:

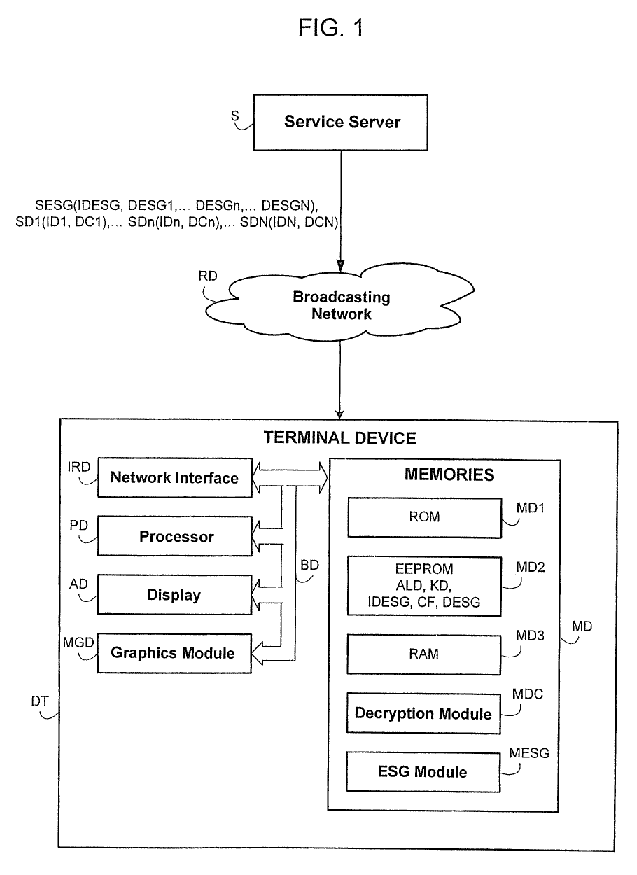

FIG. 1 is a block diagram of a first embodiment of a terminal device of the invention having access control for controlling access to services broadcast via a broadcasting network;

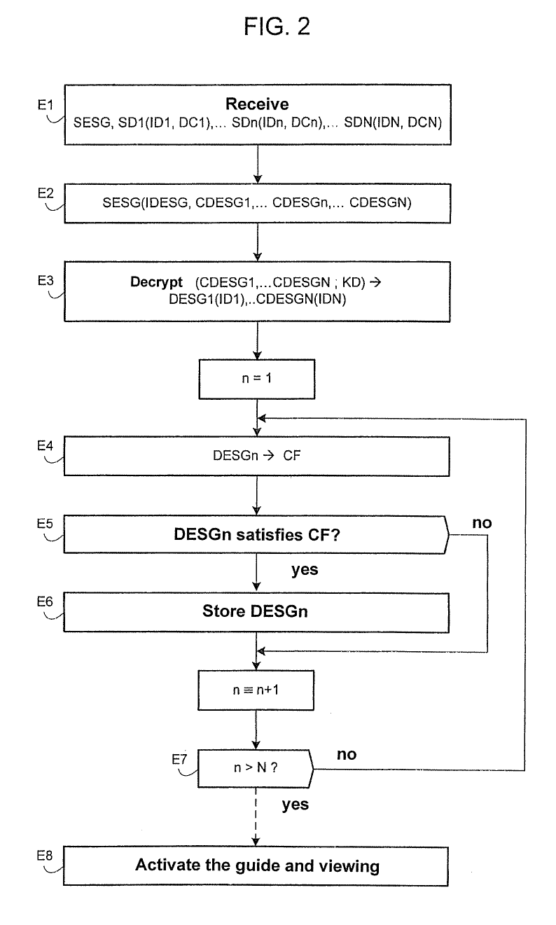

FIG. 2 is an algorithm of a method of the invention for controlling access to broadcast services, which method is implemented in the terminal device; and

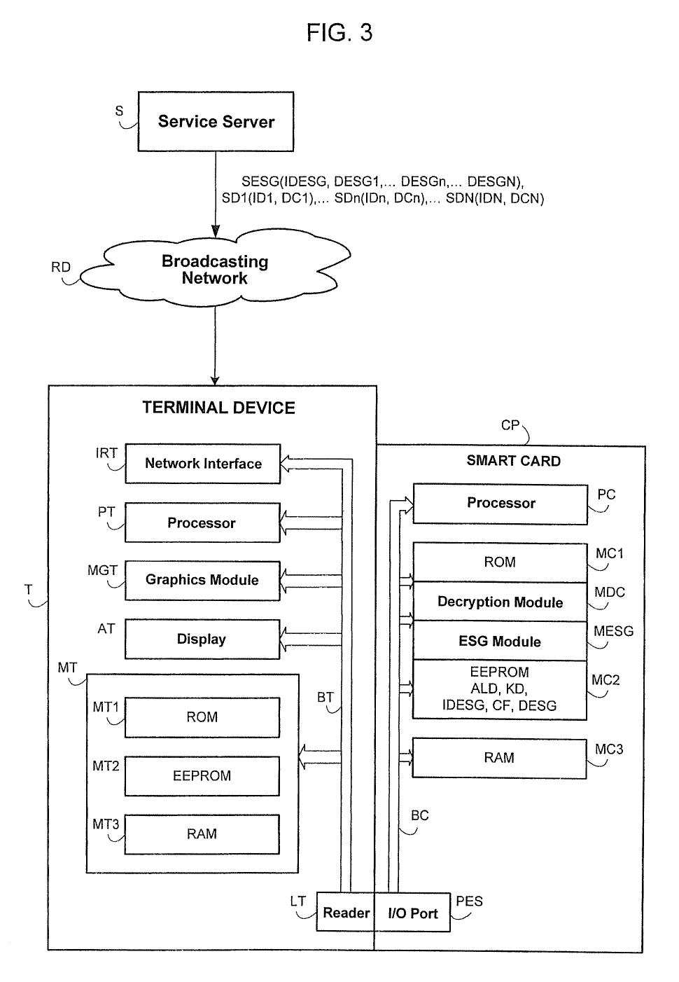

FIG. 3 is a block diagram of a second embodiment of a terminal device of the invention having access control for controlling access to broadcast services.

As shown in FIG. 1, a broadcasting network RD broadcasts service signals SESG, SD1 to SDN from one or more service servers managed by service providers to user terminal devices having access control for controlling access to broadcast services. A single terminal device DT and a single service server S managed by a given operator are shown in FIG. 1 in order to avoid cluttering it.

For example, when the terminal device DT includes functionality features of an intelligent television receiver, the broadcast network RD is a cable and/or satellite television distribution network, or a digital terrestrial television network DVB-T (Digital Video Broadcasting-Terrestrial), broadcasting digital television program services.

The broadcasting network RD broadcasts from a service server S to the terminal devices DT broadcast service signals SD1 to SDN that are identified and described in a particular service signal SESG, referred to as an “Electronic Service Guide”. A service signal SDn, where 1≦n≦N, is broadcast in the form of packets containing description data comprising at least one identifier IDn identifying the service SDn, and content data DCn of a program, e.g. a television, text, or radio program.

Reference SDn, SESG is used below to designate both a service signal and the service carried by that signal, and a service signal SDn is considered as carrying a television program or a music program. The broadcast service signals SESG, SD1 to SDN are receivable by all of the terminal devices connected to the broadcasting network RD.

The invention relates more particularly to the service constituted by the electronic service guide SESG including a guide identifier IDESG and digital description data DESG1 to DESGN describing the content data of other broadcast services DC1 to DCN respectively.

For each broadcast service SDn relating to a television program, respective description data DESGn included in the electronic service guide is constituted, for example, by: an identifier IDn and the name of the program; an identifier of the operator who is broadcasting the program, broadcasting times, a digitized rating code for the program that serves for parental control, a summary of the program, the names of the cast where applicable, reviews, digital links, such as Uniform Resource Locator (URL) addresses, to other information that can be acquired via some other communications channel, e.g. a point-to-point radiocommunications channel for mobiles, and technical information such as the type of compression of the content data associated with the service. The electronic service guide SESG is broadcast periodically by the server S, e.g. every five minutes. All of the description data DESG1 to DESGN in the electronic service guide SESG is updated in the server S, e.g. prior to broadcasting a new program over the broadcasting network, or after a program broadcast over the broadcasting network RD ends or is discontinued.

The user terminal device DT is shown in FIG. 1 in the form of function blocks, most of which provide functions related to the invention and can correspond to software and/or hardware modules.

In the first embodiment of the invention, the terminal device DT comprises a network interface IRD comprising a receiver for receiving the service signals SESG, SD1 to SDN broadcast via the network RD, a processor PD, a graphics module MGD, a display AD, and terminal memories MD.

The display AD, such as a screen, presents, i.e. displays, in particular, the description data included in the electronic service guide signal SESG. By way of a variant, a speech synthesizer and a loudspeaker of the terminal device DT present the description data phonically. The display AD can be external to the terminal device and connected thereto via a specific graphics user interface. A keyboard or keypad (not shown) is incorporated into or associated with the terminal device. The various elements of the terminal device are connected together via a both-way bus BD.

The memories MD comprise three memories MD1, MD2, and MD3, a decryption module MDC, and an electronic service guide module MESG.

The memory MD1 is a non-volatile memory of the Read-Only Memory (ROM) type or of the Flash type, and it includes the operating system of the terminal. The memory MD2 is a non-volatile memory, e.g. an Electrically Erasable Programmable Read-Only Memory (EEPROM) or a Flash memory, for storing, in particular, algorithms and keys, filter criteria, description data, and identifiers and parameters of a profile of the user of the terminal device. The memory MD3 is a Random Access Memory (RAM) or a Static Random Access Memory (SRAM) serving more particularly for data processing.

When the items of description data DESG1 to DESGN are encrypted into encrypted description data by the server S, the decryption module MDC decrypts the encrypted description data by means of a decryption algorithm ALD and of a decryption key KD, both of which are stored in the memory MD2.

The electronic service guide module MESG interprets and filters the decrypted description data DESG1 to DESGN as a function of one or more filter criteria CF read from the memory MD2, and writes the filtered description data into the memory MD2 or into the memory MD3. When said filtered description data is written into the memory MD3, then when the terminal device is switched on again, the filtered description data is no longer available in the memory MD3, and the electronic service guide module MESG interprets the description data again and filters it.

The identifier of the guide IDESG and the filter criteria CF are stored in the memory MD2. Each filter criterion is based on one or more parameters of the same type as the description data of a program and on a condition to be satisfied by program description data relative to the parameter(s). The filter criteria are predefined by the user of the terminal device and/or by the operator who supplies the terminal device.

The graphics module MGD has a graphics interface between the display AD and the electronic service guide module MESG. At the request of the user of the terminal device, the graphics module MGD formats the filtered description data in order to display it on the display AD.

The method of controlling access to broadcast services that is shown in FIG. 2 is executed by the processor PD of the terminal device DT when said terminal device is attached to the broadcasting network RD. The method is executed transparently for the user of the terminal device. The method comprises steps E1 to E8.

In step E1, the receiver in the network interface IRD receives the service signals SESG, SD1 to SDN broadcast via the broadcasting network RD. Each broadcast service signal SDn includes an identifier IDn that is also included in the respective items of description data DESGn contained in the electronic service guide signal SESG.

In step E2, the network interface IRD, selects from among the broadcast service signals SESG, SD1 to SDN only that service signal SESG that relates to the electronic service guide that is identified by the identifier IDESG of the service SESG compared with the one read from the memory MD2. Then, the network interface IRD extracts from the service signal SESG the encrypted description data CDESG1 to CDESGN containing the identifiers ID1 to IDN identifying service signals SD1 to SDN whose contents are possibly to be viewed, and the module MESG records the extracted encrypted description data.

In a variant, the encrypted description data is transmitted to the terminal device DT via a point-to-point network, such as an access network, such as a switched telephone network or a cellular radiocommunications of the GSM or UMTS type, or the Internet. To this end, the network interface IRD includes a point-to-point receive module for receiving the encrypted description data of broadcast services so as to establish and store the electronic service guide SESG.

In step E3, the decryption module MDC uses the decryption key KD and the decryption algorithm ALD to decrypt the encrypted description data CDESG1 to CDESGN so as to record the description data as unencrypted DESG1 to DESGN. The items of extracted encrypted description data DESG1 to DESGN in association with respective ones of the identifiers ID1 to IDN are processed by the module MESG so that said module establishes and formats the electronic service guide SESG, and stores it.

In a variant, the description data is transmitted unencrypted over the broadcast network RD and does not need to be decrypted.

Steps E4 to E6 correspond to processing the description data DESGn relating to one (SDn) of the broadcast program services SD1 to SDN, where the index n lies in the range 1 to N. The processing consists in filtering or in not filtering the recorded description data DESGn. Steps E4 to E6 are repeated N times so long as not all of the items of description data DESG1 to DESGN relating to the program services SD1 to SDN broadcast over the network RD have been processed.

In step E4, the electronic service guide module MESG applies one or more filtering criteria to one or more items of data DESGn relating to the program SDn, which filtering criteria are stored in the memory MD2 of the terminal device D5 and are associated with one or more filter criterion parameters chosen by an authorized user, as explained below. If, in step E5, the items of data DESGn satisfy the one or more criteria CF, then the module MESG stores, in step E6, all of the items of description data DESGn filtered in this way that relate to the program service SDn in the memory MD2 or in the memory MD3 of the terminal device DT. Otherwise, or after execution of step E6, the electronic service guide MESG processes the items of description data DESGn+1 that are not yet processed, and that relate to another program service SDn+1. In step E7, so long as not all the items of description data of the program services SD1 to SDN have been processed, the module MESG executes the steps E4 to E6.

Subsequently, in step E8, when an electronic service guide application is activated by a user of the terminal device via the keypad or keyboard of the terminal device, the graphics module MGD notifies the activation to the module MESG. Said module MESG searches the memory MD2 or the memory MD3 for all of the items of filtered description data and transmits them to the graphics module MGD which formats them in order to display them ergonomically on the display AD.

In a variant implementation of the method of the invention, the items of description data DESG1 to DESGN are stored in the memory MD2 or MD3 of the terminal device before being filtered as a function of filtering criteria. Subsequently, during activation of an electronic service guide application by a user of the terminal device, the graphics module MGD notifies the activation to the module MESG. Said module MESG executes the filtering of the description data DESGn for each broadcast service by analogy with the steps E4 and E5, the items of description data DESGn being stored in the memory MD2 or MD3. If the items of data DESGn satisfy the one or more criteria CF, then the module MESG transmits them to the graphics module MGD which formats them so as to display them ergonomically on the display AD.

In a second embodiment of the user terminal device that is shown in FIG. 3, the user terminal device is a removable smart card CP also referred to as a “microcontroller card” or as an “integrated circuit card”, which smart card operates with contact or in contactless manner, and is received by a terminal T.

In a first example, the terminal T is a mobile radio terminal for which the smart card is of the Universal Integrated Circuit Card (UICC) type. The smart card UICC is, for example, a card provided with a Subscriber Identity Module (SIM) application when the terminal is a mobile of the GSM (Global Service for Mobile Communications) type or of the GPRS (General Packet Radio Service) type. In another example, the smart card UICC is provided with a Universal Subscriber Identity Module (USIM) application, with a Removable User Identity Module (RUIM) application, or with an IP Subscriber Identity Module (ISIM) application, when the mobile terminal operates in Code Division Multiple Access (CDMA) mode of the third generation (Third Generation Partnership Project (3GPP)) of the Universal Mobile Telecommunications System (UMTS) type or of the UMTS Terrestrial Radio Access Network (UTRAN) type, or of the third generation (3GPP2) of the CDMA 2000 type.

In other examples, the terminal is a Personal Computer (PC) equipped with a smart card reader, or indeed is a small item of communicating equipment such as a Personal Digital Assistant (PDA) equipped with a smart card reader.

In further examples, the card can be a Universal Serial Bus (USB) key or stick, a Flash memory card, a secure digital card, a multimedia card, or indeed can be replaced with any removable portable recording medium having a microcontroller.

The terminal T and the smart card CP are shown in FIG. 3 in the form of function blocks, most of which provide functions related to the invention and can correspond to software and/or hardware modules.

The terminal T comprises a network interface IRT comprising a receiver and/or a point-to-point receive module for receiving the service signals SESG, SD1 to SDN broadcast via the network RD, a processor PT, a display AT, memories MT, a graphics module MGT, and a smart card reader LT. The various elements of the terminal are connected together via a both-way bus BT.

The memories MT comprise three memories MT1 to MT3 that are conventionally and respectively of the following types: ROM or Flash, EEPROM or Flash, and RAM or SRAM.

As known, the smart card CP mainly comprises a processor PC, three memories MC1 to MC3, and an input/output port PES connectable to the reader LT for the purpose of exchanging commands and responses with the terminal T. The various elements of the card are connected together via a both-way bus BC. The memory MC1 is a non-volatile memory of the ROM type or of the Flash type, and it includes the operating system of the card. The memory MC2 is a non-volatile memory, e.g. an EEPROM or a Flash memory, for, in particular, storing algorithms, keys, and identifiers and parameters of the profile of the user possessing the card. The memory MC3 is a RAM or an SRAM serving more particularly for data processing.

In the memories MC1 and MC2, the smart card contains the decryption module MDC and the electronic service guide module MESG, and, in the memory MC2, the smart card contains the decryption algorithm ALD, the decryption key KD, the filter criterion CF and filtered description data DESG.

In the second embodiment, the processor PC of the card CP executes most of the steps of the service customization method as described above with reference to the terminal T.

The items of encrypted description data CDESG1 to CDESGN are received by the interface IRT of the terminal T and are transmitted to the card CP via the reader LT of the terminal and via the port PES so that the processor PC and the decryption module MDC of the card process them. Steps E2 to E8 shown in FIG. 2 are executed mainly in the smart card CP.

When an electronic service guide application is activated in the card by the user of the device, the graphics module MGT notifies the activation to the processor PC of the card CP via the reader LT of the terminal and via the port PES. The processor PC activates the electronic service guide module MESG which searches the memory MC2 for all of the items of filtered description data and transmits them to the graphics module MGT via the port PES and via the reader LT of the terminal T. The graphics module MG formats the items of filtered and transmitted description data so as to display them ergonomically on the display AT.

In a third embodiment, the user terminal device is analogous to the user terminal device of the first embodiment and it comprises a smart card reader LT and, in particular, the memories MD and the display AD. A removable memory card is inserted into or is associated with the terminal device. The memory card comprises a non-volatile memory, e.g. of the EEPROM type or of the Flash type, connected to an input/output port PES that is connectable to the card reader LT of the terminal device. However, in the third embodiment, the processor of the terminal executes the above-described access control method, in the first implementation shown in FIG. 1. The non-volatile memory of the memory card contains the decryption key KD and the filter criteria CF, and the memory MD2 of the terminal device serves to store, in particular, algorithms and keys, filtered description data, identifiers and parameters of a profile of the user of the terminal device.

A first example of use of the invention relates to implementing parental control in a mobile terminal of the invention used by a child for accessing a function of viewing a television program. For presenting, i.e., in this example, viewing, the television program broadcast by the broadcasting network, the child activates the electronic service guide application via the keypad of the mobile terminal, and selects one of the broadcast program services proposed by the electronic service guide.

Prior to that, the description data relating to all of the program services broadcast over the broadcasting network have been filtered on the basis of at least one filter criterion which, for example, comprises a rating code value input or selected by one of the parents of the child via the keypad of the terminal and recorded in the memory MD2 or MC3, after validation of an identifier such as a secret code authorizing the rating code to be input. In the memory MD2 or MC2, the filter criteria CF are previously designated by rating codes in association with the conditions to be satisfied. For example, a rating code of value “1” authorizes viewing of programs of the cartoon type, a rating code of value “2” does not authorize viewing of programs by children under ten years, and a rating code of value “5” authorizes viewing of programs for adults. In the preceding example, the parent chooses a rating code of value “1” as the filter criterion parameter. For each broadcast program service, the electronic service guide module MESG interprets the description data received from the service and compares the rating code of the program service indicated by one of the items of description data describing the broadcast program service with the rating code indicated by the filter criterion. If the following condition associated with the chosen rating code is satisfied by the rating code of the broadcast program service, i.e. if the rating code of the broadcast program service is less than or equal to the chosen rating code of the filter criterion, all of the items of description data associated with said program service are stored by the electronic service guide MESG. Otherwise, the items of description data associated with the program service are not stored. Only the items of description data relating to cartoons are displayed on the display AD or AT on activating the electronic service guide, and the child can make a choice only from among the program services described in the displayed description data.

In another example of parental control, the filter criterion parameter corresponds to the age of the child stored, for example, in the memory MC2 of the smart card CP. The electronic service guide MESG then compares the age of the child with an item of description data of each broadcast program service, which item indicates a minimum age for authorized viewing of said program service. The items of the description data of the broadcast program services that indicate a minimum age greater than the stored age of the child are not stored in the memory MD2 of the terminal.

In a second example of use of the invention, a user of a mobile terminal T has taken out a subscription with a given operator who proposes to access television program services, as do other competing operators. The operators use the same broadcasting network RD for broadcasting their services. The services proposed by the operators are described in an electronic service guide service SESG.

For each broadcast service, the electronic service guide module MESG interprets the received items of description data that are included in the electronic service guide. For example, the network indicator MNC (Mobile Network Code) of the given operator extracted from a user identifier IMSI (International Mobile Subscriber Identity) previously stored in the memory MC2 of the smart card associated with the terminal T, constitutes the filter criterion parameter, and is compared by the electronic service module MESG with an operator identifier which constitutes description data relating to the broadcast service. If the broadcast service is supplied by the given operator, or by a partner whom the given operator has chosen for service broadcasting and whose identifier is stored as a filter parameter, all of the items of description data thus filtered that are associated with this service are stored in the memory MD2 by the electronic service guide module MESG. When the user selects a service broadcast via the electronic program guide, said user can make a choice only from among the services of the given operator and not from among the services of competitor operators.

The invention described herein relates to a method and to a terminal device for controlling access to services that are broadcast via a broadcasting network. In a preferred implementation, the steps of the method are determined by the instructions of a program that is suitable for being implemented in the terminal device DT such as a computer, a digital television receiver, or a mobile terminal, or any other communicating intelligent terminal connected to a broadcasting network, or indeed suitable for being implemented in a portable electronic object having a microcontroller, such as a smart card, in association with such a terminal device or with a terminal. The program includes instructions that perform the steps of the method of the invention when said program is executed in the terminal device or portable electronic object, operation of which is then controlled by executing the program.

Said program can use any programming language, and be in the form of source code, object code, code interpretable by a virtual machine, or intermediate code between source code and object code such as in a partially compiled form, or in any other form desirable for implementing the method of the invention.

1. A method implemented in a terminal device for the purpose of controlling access to broadcast services that are broadcast via a broadcasting network, one of the services being an electronic service guide stored in the terminal device and containing description data that describes the other broadcast services, said method comprising: filtering the items of description data of the electronic service guide that relate to the broadcast services as a function of at least one filter criterion; and presenting the filtered items of description data of the electronic service guide that satisfy the filter criterion so that the services associated with the presented filtered items of description data are selectable.

2. A method according to claim 1, in which the filtered items of description data that satisfy the filter criterion are stored, and, on activation of the electronic service guide, the stored filtered items of description data are presented.

3. A method according to claim 1, in which all of the items of description data of the electronic service guide are stored, and, on activation of the electronic service guide, the stored items of description data are filtered as a function of the filter criterion to be satisfied, and are then presented.

4. A method according to claim 1, in which the filtering of the description data relating to a broadcast service comprises, for each broadcast service: comparing an item of description data describing the broadcast service with a filter criterion parameter.

5. A method according to claim 1, further comprising: decrypting the description data describing the broadcast services.

6. A method according to claim 1, in which said at least one filter criterion depends on a digitized code corresponding to parental control.

7. A method according to claim 1, in which said at least one filter criterion depends on an identifier of an operator managing the broadcasting network or of a partner of the operator.

8. A method according to claim 1, further comprising: selecting from among the broadcast service signals, that service signal that relates to the electronic service guide and that includes the description data describing the other broadcast services, the items of description data describing a service including an identifier identifying the service and also being included in the service itself in order to present the description data describing the service and in order to select the service.

9. A terminal device having access control for controlling access to broadcast services that are broadcast via a broadcasting network, one of the services being an electronic service guide stored in the terminal device and containing description data that describes the other broadcast services, said terminal device comprising: means for filtering the items of description data of the electronic service guide that relate to the broadcast services as a function of at least one filter criterion; and means for presenting the filtered items of description data of the electronic service guide that satisfy the filter criterion so that the services associated with the presented filtered items of description data are selectable.

10. A terminal device according to claim 9, comprising a mobile terminal including the filter means, means for storing the description data, and the presentation means.

11. A terminal device according to claim 10, in which the mobile terminal includes means for decrypting the description data describing the broadcast services.

12. A terminal device according to claim 10, in which a memory card is associated with the terminal and stores said at least one filter criterion.

13. A terminal device according to claim 9, comprising a terminal including the presentation means, and a smart card associated with the terminal including the filter means and means for storing the description data.

14. A terminal device according to claim 13, in which the smart card includes means for decrypting the description data describing the broadcast services.

15. A computer-readable medium containing a program suitable for being implemented in a terminal device for the purpose of controlling access to broadcast services that are broadcast via a broadcasting network, one of the services being an electronic service guide stored in the terminal device and containing description data that describes the other broadcast services, said program comprising instructions which, when the program is executed in said terminal device, implement the following steps:
filtering the items of description data of the electronic service guide that relate to the broadcast services as a function of at least one filter criterion; and
presenting the filtered items of description data of the electronic service guide that satisfy the filter criterion so that the services associated with the presented filtered items of description data are selectable.
